(19) United States
(12) Patent Application Publication
(10) Pub. No.: US 2007/0283577 A1
(43) Pub. Date: Dec. 13, 2007

(54) Guide Tool for Cutting Fine Kernels of Corn

(76) Inventor: Virgil Harris, Point Marion, PA (US)

Correspondence Address: MCKAY & ASSOCIATES, PC., 801 MCNEILLY ROAD, PITTSBURGH, PA, 15226, US

(21) Appl. No.: 11/423,282

(22) Filed: Jun. 9, 2006

(51) Int. Cl. B26B 3/00

(52) U.S. Cl. 30/302

(57) ABSTRACT

The present invention comprehends a tool for cutting fine kernels of corn from ears of corn, comprising generally U-shaped guide having two ends, with each end defining a slit. Each slit is adapted to frictionally situate the blade of a knife therein. A horizontal member connects each end at the base of each end, and the horizontal member is positioned offset from and parallel to the center axis of the guide such that when said blade is axially and centrally positioned between the slits of the tabs, the blade is parallel to and offset from the horizontal member. In this configuration, the horizontal member acts as a guide so that when the blade is forced down an ear of corn the size of the corn kernels removed from the ear remain consistently fine.

### BACKGROUND

1. Field of the Invention

The present invention relates to tools for cutting or grating corn kernels from ears of corn. Particularly, the invention is a guide which is adapted to secure a blade for manually forming fine kernels of corn as the corn is stripped from corn on the cob.

2. Description of the Related Art

Devices for removing corn from ears of corn are known in the art. U.S. Pat. No. to Skolrud (2,415,114) describes a manual corn cutter which has a trough and an arched cutter. The handle is a cup-shaped deflector. U.S. Pat. No. to Lee (2,282,660) and U.S. Pat. No. Miles (4,892,034) also show trough-like inventions. These bulky items are potentially expensive and not easily cleanable. Furthermore, the blade assemblies can be quite dangerous.

The above devices and the other prior art are not adapted to secure traditional knives or blades in a horizontal position guided by a sheath, rather they are specialized, complex devices. Those prior art devices which are one-piece cutting tools having a blade component which is circular and cumbersome. This arrangement would require the ears of corn have a particular diameter to work properly, and only a partial length of the ear can be stripped at one time. Furthermore, these tools can easily get caught on the cob as they dig down into it, forming irregularly sized, bulky kernels of corn. See for instance U.S. Pat. Nos. 2,188,020, 4,402,137, and 4,885,842 to Marley.

There is a need then for a tool which can manually and safely form small, fine kernels of corn such that young children, the elderly, or others who have trouble eating large corn kernels can eat the corn after being stripped from the cob.

### SUMMARY

The present invention comprehends a generally U-shaped guide having two ends, each said end being v-shaped in cross-section to form a pair of tabs defining a slit, each said slit adapted to frictionally situate the blade of a knife therein; a horizontal member connects each said end at the base of each end, said horizontal member positioned offset from and parallel to the center axis of the guide such that when said blade is axially and centrally positioned between the slits of the tabs, the blade is parallel to and offset from the horizontal member. In this configuration, the horizontal member acts as a guide so that when the blade is forced down an ear of corn the size of the corn kernels removed from the ear remain consistently fine, sized generally with a height similar to the distance d1 from the horizontal member to the blade.

### BRIEF DESCRIPTION OF THE DRAWINGS

FIG. 1 shows a front view of the present invention showing the guide without the blade or knife.

FIG. 2 shows the same front view of FIG. 1 but with a blade of a knife situated therein.

FIG. 3 is a side view of the present invention revealing the v-shaped ends.

FIG. 4 is a top view of the present invention indicating the offset horizontal member.

### DETAILED DESCRIPTION OF THE PREFFERED EMBODIMENT

The invention will now be described in detail in relation to a preferred embodiment and implementation thereof which is exemplary in nature and descriptively specific as disclosed. As is customary, it will be understood that no limitation of the scope of the invention is thereby intended. The invention encompasses such alterations and further modifications in the illustrated kit assembly, and such further applications of the principles of the invention illustrated herein, as would normally occur to persons skilled in the art to which the invention relates. This detailed description of this invention is not meant to limit the invention, but is meant to provide a detailed disclosure of the best mode of practicing the invention.

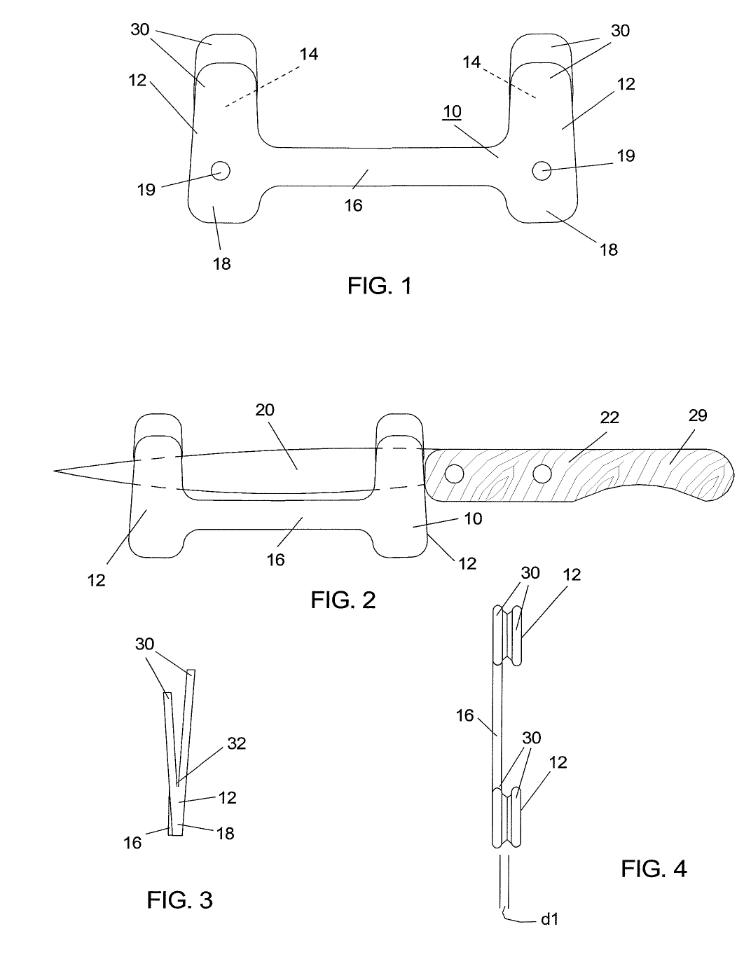

With reference then to FIGS. 1-4, shown is the generally U-shaped guide 10. The guide 10 can be made of any suitable material such as metal, having two halves fastened using rivets 19, screws, or other connection means. In a further embodiment, guide 10 can be made as a one-piece, molded plastic.

Guide 10 has two ends. Each end 10 is v-shaped in cross-section as viewed lengthwise along the axis of the guide 10, forming a pair of tabs 30. Furthermore, each end 10 has a base 18 preferably wider than the uppermost portion of end 10. Each tab 30 is angled away from the longitudinal, central axis and joined at apex 32 to define a slit 14. Each slit 14 is adapted to frictionally situate the blade 20 of a knife 22 therein. The blade 20 customarily may protrude from the handle 29 of a knife 22 to be removably situated within slits 14, or the blade 20 can be attached or fixed within slit 14 as an integral component of guide 10. In the preferred embodiment, one tab 30 at each end 10 is longer than the opposing tab 30. In this configuration, the pair of back tabs is taller than the front tabs to ease the placement of blade 20 within the slits 14 defined by the tabs 30.

A rigid, horizontal member 16 integrally connects each end 12 at or near the base 18 of each end 12 to define the length of guide 10. Horizontal member 16 adds rigidity to guide 10. The length of horizontal member 16 and thus guide 10 may obviously vary depending on the length of the blade 20. It is also envisioned that a kit can be manufactured comprising variably sized guides 10 so that the guides 10 can be used with different types of knifes 22.

Horizontal member 16 is positioned offset a distance d1 from the center axis of guide 10, and parallel to the center axis. As a result of this configuration, when blade 20 is axially and centrally positioned between the slits 14 of the tabs, the blade 20 is parallel to and offset from the width of the horizontal member 16 the same distance d1. Thus, the horizontal member 16 acts as a planar guide or stop surface for abutting and traveling along the ear of corn so that when the blade 20 is forced down along an ear of corn, the size of the corn kernels removed from the ear remain consistently fine and similarly sized, generally with a height similar to the distance d1. By providing a small distance d1, very fine corn pieces can be removed from the ear because the blade 20 can only penetrate into the corn the distance d1 as the knife 22, using handle 29, is moved down along the ear of corn.

I claim:

1. A tool for forming fine kernels of corn from an ear of corn, comprising:
a u-shaped guide having a longitudinal, center axis and two ends, each said end having a base and being v-shaped in cross-section to form a pair of tabs, each said tab being angled away from said longitudinal, center axis and joined at an apex to define a slit, each said slit adapted to frictionally situate a blade therein;
a horizontal member integrally attached to each said end near said base positioned parallel to said longitudinal, center axis, said horizontal member positioned offset from said center axis of said guide such that when said blade is axially and centrally positioned between said slits of said tabs, said blade is parallel to and offset from said horizontal member by a distance d1, whereby said fine kernels of corn are sized generally with a height similar to said distance d1 when said blade is moved along said ear of corn.

2. The tool of claim 1, wherein one of said tabs of said pair of tabs is longer than an opposing tab.

3. The tool of claim 1, wherein said blade protrudes from a handle of a knife.

4. The tool of claim 1, wherein said blade is fixedly attached to said guide within said slit.

5. The tool of claim 1, wherein said base is wider than an uppermost portion of said end.
